(19) United States
(12) Patent Application Publication
(10) Pub. No.: US 2007/0058649 A1
(43) Pub. Date: Mar. 15, 2007

(54) Packet queuing system and method

(75) Inventors: Jouni Kytomaa, Espoo (FI); Janne K. Peltonen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 10/567,851

(22) PCT Filed: Jun. 14, 2005
(86) PCT No.: PCT/IB05/01971

§ 371 Date: Oct. 6, 2006

(30) Foreign Application Priority Data
Jun. 16, 2004 (GB) 0413482.1

(51) Int. Cl. H04L 12/56

(52) U.S. Cl. 370/412

(57) ABSTRACT

There is disclosed a method of queuing packets received at an input to at least one device for processing, the method comprising the steps of: allocating each received packet to at least one arrival queue of the device; placing each packet in the allocated queue if said queue is not full, otherwise dropping said packet; scheduling packets from the device arrival queue to at least one transfer queue; responsive to transfer of a packet to a transfer queue, generating an interrupt from the device to a processor; at the processor, responsive to receipt of an interrupt, allocating the packet to one of a plurality of processor queues; placing the packet in the allocated processor queue if said queue is not full, otherwise dropping said packet; and scheduling packets from the processor queues for processing.

### BACKGROUND OF THE INVENTION

1. Field of the Invention

The invention is related to the queuing of packets, and particularly but not exclusively to the queuing of packets at the input of a processing device.

2. Description of the Related Art

A UNIX like operating system consists of a kernel, which is the core of the operating system, and processes that are allocated CPU (central processor unit) run time by the kernel. Different applications can be implemented as processes. The kernel takes care of asynchronous events, such as interrupts from hardware devices. The routines that handle interrupts are called “interrupt service routines”. The kernel also provides services for the processes.

For high-speed devices, such as network interface cards, interrupts occur with a high priority.

The frequency of interrupts depends on the frequency of the arriving packets. Even if interrupts are issued less frequently than packets arrive, the rate of interrupts can still be quite high.

An interface card must acknowledge receipt of a packet quickly so that it can accept more packets. This is a relatively light process compared to processing of the actual packet. Therefore, the packets are usually placed on a work queue to be scheduled later on. This is done in order to avoid spending too much time in interrupt service routines and allow critical processes and other functions run-time. The mechanism for informing the kernel about queued lower-priority work is termed a “software interrupt”. The processing of the packet is eventually handled by a function, and the packet is removed from the work queue. User space processes are pre-empted by both hardware and software interrupts.

Queuing in this context refers to storing packets for subsequent processing. Typically, queuing occurs within any network device, such as a router, when packets are received by the device (input queue), and prior to transmitting the packets to another device (output queue). By queuing the packets the device can tolerate variations in input/output processing. By queuing packets in multiple queues and applying scheduling (how packets are taken from the queues and moved onwards) the device can support quality of service.

Quality of Service (QoS) is the end-to-end provision of a consistent, predictable data delivery service to a certain traffic class or user. Enabling QOS requires the cooperation of all network layers from top-to-bottom, as well as every network element from end-to-end.

Packet traffic can be categorized by its requirements for delay and importance relative to other packet traffic. For example, traffic from a real-time service such as voice-over-IP requires low delay and low drop probability, whereas traffic from non-real-time service such as web browsing does not require such a strict delay characteristic nor does it matter so much if packets are dropped, because the traffic is protected by transmission control protocol (TCP) for HTTP traffic.

Differentiated Services (DiffServ) is an IETF specified QoS mechanism that handles traffic flows in one or more networks. In the DiffServ framework, packets carry information of their traffic class in the IP header. The Diffserv scheme does not require any signalling since packets are marked at source or at the edge of the network with priority information, and inside the network the packets are treated according to this information at each hop (i.e. at each step in the network such as a router). A key characteristic of Diffserv is that there are no absolute guarantees for any traffic class. The guarantees are relative to other traffic classes. For example, voice-over-IP is guaranteed to have the lowest drop probability and the lowest delay of all traffic classes, whereas HTTP traffic suffers more in congestion situations in terms of packets dropped and experienced delay. Each packet is also treated the same way as others belonging to the same traffic class.

Traditionally quality of service is enforced for packets which are going out of a network interface. Link congestion, where the network element transmits more packets than a network link can handle, is only part of the problem. Today network interfaces have a very large capacity and a typical general purpose processor can be easily overrun by packets arriving from the network. When the processor becomes overloaded packets are dropped randomly without any QoS treatment, and the existing QoS mechanisms become irrelevant.

When a device receives packets, the packets can be dropped and/or experience delay in the various processing stages. Packets are especially likely to be dropped after interrupt service routines and before actual packet processing. This happens because hardware interrupts are serviced (and interrupt service routines are run) at a higher priority than other tasks in the processor. When the hardware interrupt servicing takes less than 100% of CPU time, which is usually the case, the packets will be correctly placed to a queue waiting for further processing. If the queue becomes full packets are dropped. Since packets destined for a particular processing service are not typically queued in multiple queues, all packets arriving in that queue will be treated in the same manner (drop if queue is full). High priority packets have the same drop probability and delay characteristics as low priority packets. Therefore, quality of service cannot be guaranteed in all processor and bus load situations.

It is an aim of the invention to provide an improved technique for queuing packets.

### SUMMARY OF THE INVENTION

According to the invention there is provided a method of queuing packets for processing, the method comprising the steps of: allocating each received packet to at least one arrival queue; placing each packet in the allocated queue if said queue is not full, otherwise dropping said packet; scheduling packets from the arrival queue to at least one transfer queue; responsive to transfer of a packet to a transfer queue, generating an interrupt; responsive to receipt of an interrupt, allocating the packet to one of a plurality of processor queues; placing the packet in the allocated processor queue if said queue is not full, otherwise dropping said packet; and scheduling packets from the processor queues for processing.

Packets may be received at an input to a plurality of devices.

At least one device may include a plurality of arrival queues. Each arrival queue may be associated with a traffic class, each packet being allocated to the at least one queue in accordance with the traffic class of each packet. The traffic class may be priority information embedded in the each packet.

At least one device may comprise a plurality of transfer queues.

The number of transfer queues for each device may be less than the number of arrival queues for each device.

The scheduling of packets from the arrival queue to the transfer queue may be dependent upon one or more of: the traffic profile; the quality of service requirement; or the characteristics of the transfer queues.

The transfer queue may comprise a device level transfer queue and a processor level transfer queue, wherein the device level transfer queue receives packets from the arrival queue, and the processor level transfer queue receives packets from the device level transfer queue.

Packets may be transferred to the processor level transfer queue from the device level transfer queue whenever there is space in the processor level transfer queue.

Packets may never be dropped from the transfer queue.

The processor queues may be associated with different priorities. The highest priority queue may have the lowest drop probability and the lowest latency.

Responsive to receipt of an interrupt from a device, a packet may be removed from the transfer queue of the device and classified.

The classification may be based on a determination of priority. The packet may be allocated to a processor queue in accordance with its classification. The packet may be placed in the allocated processor queue if said queue is not full, otherwise the packet is dropped.

In a further aspect the invention provides a system including a processor and at least one device, in which system: packets for processing by the processor are received at an input of the at least one device, wherein the at least one device includes: allocating means for allocating each received packet to at least one arrival queue of the device; placement means for placing each packet in the allocated queue if said queue is not full, otherwise dropping said packet; scheduling means for scheduling packets from the device arrival queue to at least one transfer queue; and interrupt means, responsive to transfer of a packet to a transfer queue, for generating an interrupt from the device to a processor; and wherein the processor includes: allocation means, responsive to receipt of an interrupt, for allocating the packet to one of a plurality of processor queues; placement means for placing the packet in the allocated processor queue if said queue is not full, otherwise dropping said packet; and scheduling means for scheduling packets from the processor queues for processing.

The system may include a plurality of devices adapted to receive packets for processing by the processor at inputs thereof.

At least one device may be adapted to provide a plurality of arrival queues

Each arrival queue may be associated with a traffic class, each packet being allocated to the at least one queue by the allocation means in accordance with the traffic class of each packet.

The traffic class may be priority information embedded in the each packet.

At least one device may include a plurality of transfer queues.

The number of transfer queues for each device may be less than the number of arrival queues for each device.

The scheduling means may be responsive to one or more of: the traffic profile; the quality of service requirement; or the characteristics of the transfer queues.

The transfer queue may comprise a device level transfer queue and a processor level transfer queue, the device level transfer queue being adapted to receive packets from the arrival queue, and the processor level transfer queue being adapted to receive packets from the device level transfer queue.

The system may be adapted such that packets are transferred to the processor level transfer queue from the device level transfer queue whenever there is space in the processor level transfer queue.

The system may be further adapted such that packets are never dropped from the transfer queue.

The processor queues may be adapted to be associated with different priorities.

The system may be adapted such that the highest priority queue has the lowest drop probability and the lowest latency.

The processor may include transfer means adapted, responsive to receipt of an interrupt from a device, to remove a packet from the transfer queue of the device, and provide such to a classification means for classification.

The classification may be adapted to be based on a determination of priority.

Embodiments of the invention relate to packet processing implemented in software running on a general purpose processor or similar system.

Embodiments of the invention place packets into multiple queues after an interrupt service routine and before an actual packet processing in the following manner: the packet priority is read from the packet header; based on the packet priority the packet is placed on one of the queues; and there are 2 to N queues for a particular packet processing function.

A scheduler with a suitable algorithm(s) then preferably moves packets from the N queues and passes them on to the appropriate packet processing stage.

The invention, and embodiments thereof, thus provides flow control at a device level, preferably by means of a device level scheduler, to ensure that the processor only receives an amount of packets that it is able to process at the interrupt stage.

The processor level scheduler, which is preferably provided, ensures that the quality of service rules are followed in an overload situation for those packets that are already past the interrupt stage.

Multiple queues are preferably provided at each stage. In some stages multiple queues are needed to make it possible to drop packets according to selected quality of service schemes. Preferably packets are dropped either at the arrival queues or at the last processor queues. In all stages, the preferable provision of multiple queues makes it possible to offer low delay to traffic classes that need that property.

In a further aspect there is provided a device adapted for queuing packets to be processed, the device including: allocating means for allocating a received packet to at least one arrival queue; placement means for placing each packet in the allocated queue if said queue is not full, otherwise dropping said packet; scheduling means for scheduling packets from the arrival queue to at least one transfer queue; and interrupt means, responsive to transfer of a packet to a transfer queue, for generating an interrupt; allocation means, responsive to receipt of an interrupt, for allocating the packet to one of a plurality of processor queues; placement means for placing the packet in the allocated processor queue if said queue is not full, otherwise dropping said packet; and scheduling means for scheduling packets from the processor queues for processing.

The device preferably includes a plurality of arrival queues

Each arrival queue may be associated with a traffic class, each packet being allocated to the at least one queue by the allocation means in accordance with the traffic class of each packet.

The device may include a plurality of transfer queues.

The transfer queue may comprise a device level transfer queue and a processor level transfer queue, the device level transfer queue being adapted to receive packets from the arrival queue, and the processor level transfer queue being adapted to receive packets from the device level transfer queue.

The device may be adapted such that packets are transferred to the processor level transfer queue from the device level transfer queue whenever there is space in the processor level transfer queue.

The device may be further adapted such that packets are never dropped from the transfer queue.

The processor queues may be adapted to be associated with different priorities.

The device may further include transfer means adapted, responsive to receipt of an interrupt, to remove a packet from the transfer queue of, and provide such to a classification means for classification.

The device may further include means to allocate the packet to a processor queue in accordance with its classification.

The placement means may be adapted such that the packet is placed in the allocated processor queue if said queue is not full, and otherwise the packet is dropped.

### BRIEF DESCRIPTION OF THE FIGURES

The invention is described by way of example with reference to the accompanying drawings, in which:

FIG. 1 illustrates an exemplary environment within which embodiments of the invention may be implemented;

FIG. 2 illustrates an exemplary implementation of a first part of a queuing arrangement in an embodiment of the invention;

FIG. 3 illustrates preferred process steps for implementing an arrival queue in the embodiment of FIG. 2;

FIG. 4 illustrates preferred process steps for implementing for implementing a device transfer queue in the embodiment of FIG. 2;

FIG. 5 illustrates an exemplary implementation of a second part of a queuing arrangement in an embodiment of the invention; and

FIG. 6 illustrates preferred process steps for implementing the embodiment of FIG. 5.

### DESCRIPTION OF PREFERRED EMBODIMENTS

The invention is described herein by way of reference to particular non-limiting examples.

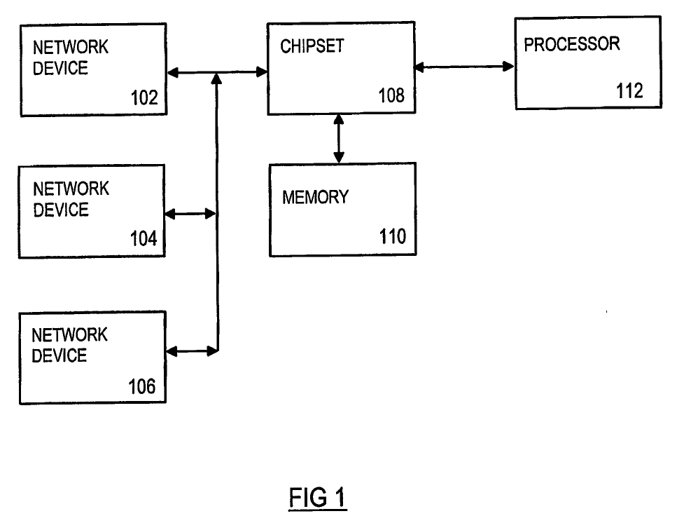

Referring to FIG. 1, there is illustrated a typical example environment within which the invention may be implemented. A plurality of network devices 102,104,106 are shown. Each network device is provided with an interface to a bus 114. A chipset 108 is also provided with an interface to the bus 108. The chipset 108 is associated with a memory 110 and a processor 112.

The processor 112 processes packets received by the chipset 108 on the bus 114. Packets are received by the chipset 108 and stored or buffered in the memory 110 until the processor 112 is ready to process them. The invention, and embodiments thereof, is utilised to control the buffering of data packets, as described in further detail below.

The chipset 108 may, in practice, receive packets from any type of other device. For example, the chipset may receive packets from a switch fabric. The bus 114 may be any type of bus, for example a PCI bus, the processor 112 for example being a Pentium III processor or such like. There may also be provided multiple buses. The invention is not, however, limited to the packets being received on a bus.

The invention will now be described by way of reference to a specific exemplary queuing arrangement as illustrated.

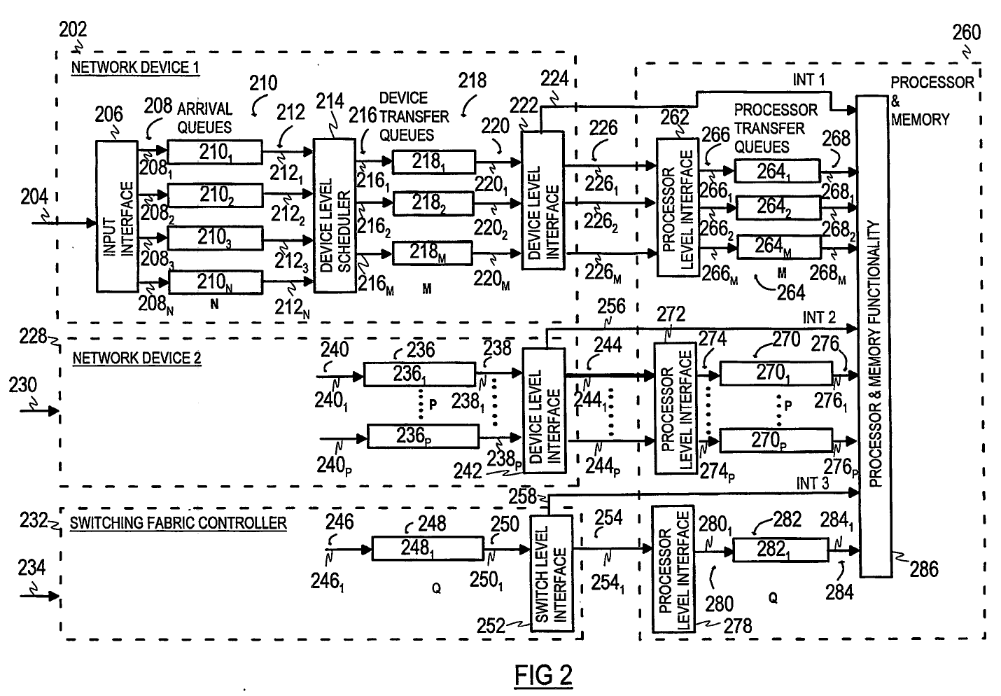

Referring to FIG. 2, there is illustrated a high level view of a processor ingress path for describing an exemplary embodiment of the invention. Reference numeral 260 represents a processor and memory block, and reference numerals 202, 228, and 232 denote devices connected to the processor and memory block 260. In the exemplary embodiment, block 202 is a first network device, block 228 is a second network device, and block 232 represents a switching fabric controller. The devices 202, 228, and 232 are examples of devices that may be connected to the processor. Other devices may also be connected to the processor. In addition there may be more devices than the devices shown in FIG. 2.

The ingress path within the first network device 202 is now explained in further detail. The first network device 202 receives arriving packets on an input line 204. The arriving packets on the input line 204 are received at a device input interface 206. The input interface 206 allocates the arriving packets to one or more arrival queues. The first network device 202, in the exemplary embodiment, is provided with N arrival queues. Thus each arriving packet is allocated to one of N arrival queues, as denoted by queues 210₁ to 210_{N}. The input interface 206 is provided with N outputs, 208₁ to 208_{N} connected to each of the N arrival queues respectively. Each of the N arrival queues has a respective output 212₁ to 212_{N}. Thus, in general, the input interface 206 allocates an arriving packet to one of the N arrival queues 210, the plurality of arrival queues 210 having a corresponding plurality of inputs 208 and a corresponding plurality of outputs 212.

Each individual device may be provided with a different number of arrival queues. Thus, N may be one or more for any device.

Each of the N arrival queues is preferably associated with a particular traffic class. Thus, the input interface 206 allocates arriving packets to the arrival queues in dependence upon the class of the arriving packets. When any arrival queue 210 becomes full, any packets destined for that queue are dropped. Thus all packets arriving at the input of the network device 202 are directed to one of the N arrival queues 210, in dependence on the traffic class associated with the respective packets.

The traffic class used for allocating arriving packets to the arrival queues may be priority information embedded in the packets themselves. Each of the N queues may represent a certain traffic class, for example, a 3G network traffic class, a differentiated service traffic class, or a special plurality class for internal traffic or signalling traffic. The outputs 212₁ to 212_{N} of the arrival queues form inputs to a device level scheduler 214. The device level scheduler 214 transfers packets from the N arrival queues to M device transfer queues. The M device transfer queues are denoted by reference numeral 218, and comprise M device transfer queues 218₁ to 218_{M}. The device level scheduler 214 has a plurality M of outputs 216, denoted 216₁ to 216_{M}, each forming a respective input for one of the device transfer queues 218₁ to 218_{M}. The device transfer queues 218₁ to 218_{M} have a respective plurality of M outputs, denoted 220₁ to 220_{M}.

In the preferred embodiment, the number of device transfer queues M is less than or equal to the number of device arrival queues N. The mapping of the N queues to M queues depends on: (i) traffic profile; (ii) QoS requirement; and (iii) the characteristics of the transfer queues. In practice, the number of device transfer queues may be limited to only one or two queues. In an example where M=2, one queue may be used for the most important traffic class and all other traffic placed in the other queue. Thus each transfer queue 218 corresponds to a certain flow control and transfer functionality.

The outputs 220₁ to 220_{M} of the device transfer queues 218 form inputs to a device level interface 222. The device level interface provides outputs 226₁ to 226_{M} to a processor level interface 262.

The processor level interface 262 provides outputs on lines 266₁ to 266_{M} to respective processor transfer queues 264₁ to 264_{M}. Each of the processor transfer queues has a respective output on lines 268₁ to 268_{M}.

Thus, the packets in the device transfer queues 218 are transferred to corresponding processor transfer queues 264. Each device transfer queue 218 therefore corresponds to a certain processor transfer queue 264 located in the processor part of the system 260. The number of processor transfer queues 264 corresponds to the number of device transfer queues. The processor transfer queues 264 are specific to the device 202.

Packets are not dropped from the device transfer queues 218 or the processor transfer queues 264. The device level scheduler 214 does not attempt to transfer packets to a device transfer queue 218 that does not have enough space in it.

The purpose of the device level interface 222 and the processor level interface 262 are to provide flow control and transfer functionality to transfer packets from the device transfer queues 218 to the processor transfer queues 264. The transfer of packets from any device transfer queue 218 to a respective processor transfer queue 264 occurs whenever there is space in the particular processor transfer queue. The information of available space is communicated over a transfer bus via connections not illustrated in FIG. 2, with any suitable algorithm or method as known in the art.

Each other device connected to the processor and memory 260, such as device of 228 and 232, is provided with arrival queues and device transfer queues as described hereinabove with reference to the first network device 202. For each of the second network device and the switching fabric controller 232, the packets arrive on a respective input line 230 and 234. The arrival queues for each of the devices 228 and 232 is not illustrated for simplification of the drawing. Each of the devices may have any number of arrival queues, being one or more, in dependence upon the configuration of the device. The packets in the arrival queues are allocated to device transfer queues by a device level scheduler, as described hereinabove with reference to the first network device 202. The device transfer queues for each of the second network device 228 and the switching fabric controller 232 are illustrated in FIG. 2.

The second network device 228 is provided with P device transfer queues 236, denoted 236₁ to 236_{P}. The P device transfer queues each have a respective input line 240₁ to 240_{P}. The device transfer queues 236 each have a respective output 238₁ to 238_{P}, each of which forms an input to a device level interface 242 for the second network device 228. As for any device, the number of device transfer queues may be any number of one or more. Thus P may be equal to any number. The device level interface 242 of the second network device 228 transfers packets in the P device transfer queues to corresponding P processor transfer queues in the processor and memory 260, as denoted by reference numerals 270₁ to 270_{P}. A processor level interface block 272 for the second network device 228 receives the packets from the device level interface block 242 on signal lines 244₁ to 244_{P}. The processor level interface block 272 outputs the received packets on a respective output line 274₁ to 274_{P}, forming inputs to the respective ones of the P queues 270. The P queues 270 have respective outputs on output lines 276₁ to 276_{P}.

In the switching fabric controller 232, there are provided Q device transfer queues. Again, there may be one or more arrival queues. In the example of the switching fabric controller 232, there is illustrated only a single device transfer queue, 248₁. The device trasnfer queue has an input line 246₁, and an output line 250₁. The output line is connected to a switch level interface 252 for the switching fabric controller 232. The switch level interface 252 provides packets from the device transfer queue 248₁ on line 254₁ to a processor level interface 278 for the switching fabric controller 232. At the processor side, there is provided an equivalent number of processor transfer queues Q, in this example being one queue denoted 282₁. The processor level interface 278 provides packets on an output line 280₁ to the queue 282₁, which in turn has an output 284₁.

Referring further to FIG. 2, it can be seen that each of the switch or device level interfaces 222, 242, or 252 additionally generates an interrupt. The device level interface 222 generates an interrupt INT 1 on line 224, the device level interface 242 generates an interrupt INT 2 on line 256, and the switch level interface 252 generates an interrupt INT 3 on line 258. Each of the interrupts on lines 224, 256, 258, and the outputs of each of the processor transfer queues on lines 268, 276, and 284, are received as inputs by a processor and memory functionality block 286 of the processor and memory block 260. The operation of the processor and memory functionality block 286 is described in further detail hereinbelow.

Each of the processor transfer queues 264, 270, and 282 is located in the processor and memory part 260. The appropriate device notifies the processor and memory 260 when it has transferred a certain amount of packets into the processor transfer queues. After that, the processor and memory functionality block 286, as is described in further detail hereinbelow, selects one of the queues for processing. The selection of the queue for processing may be based on any suitable algorithm, for example weighted round robin scheduling. The packet processing functionality of the processor and memory functionality block 286 then processes the packets one-by-one.

At each stage, the highest priority queue is provided with the lowest drop probability and the lowest latency.

In accordance with embodiments of the invention, multiple arrival queues are provided for queuing packets. In general, any number of 1 or more arrival queues may be provided. The arrival queues are preferably associated with priorities. Each incoming packet is then also preferably associated with a priority, which priority corresponds to a priority of one of the arrival queues. In a simple example, a packet may have one of two priorities, and two arrival queues each associated with a respective priority may be provided. In general, a packet may have one of ‘n’ priorities, and there may be provided ‘n’ arrival queues.

It should be noted, however, that where n priorities are provided, there may be more than n arrival queues provided, certain arrival queues having the same priority. In general, it is preferred that there is at least one arrival queue for each priority. However, in practice this may not be the case, and multiple priorities may map to a single queue.

It should also be noted that the length of the arrival queues for each priority may be the same or may be different. Where it is known or expected that particular packets of a particular priority level will be prevalent, a longer arrival queue for such priority level may be provided.

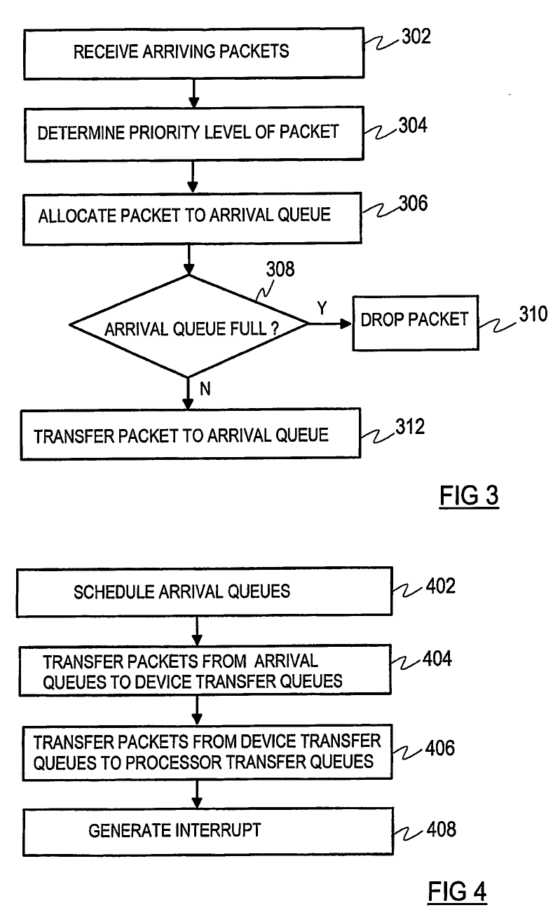

The operation of the invention in the specific arrangement of FIG. 2 is now described with additional reference to the flowchart of FIG. 3.

Referring to FIG. 3, in a step 302 a packet is received at an input interface of a device, such as the input interface 206 of the first network device 202. In a step 304, there is then determined a priority level of each arrival packet. As discussed above, preferably there is an arrival queue for each priority level, and the packet is then allocated to the appropriate arrival queue in step 306.

In the embodiments described herein, it is assumed that a priority of any given packet is indicated by a priority indicator included in the header of the packet. The identification and indication of a priority of a packet is outside the scope of the invention, and any known technique for denoting the priority of a packet may be used. The packet may have a field or multiple fields which can be used to find out its priority. The invention, or embodiments thereof, does not propose a new technique for allocating priorities to packets, or of identifying the priority of a packet within the packet.

In a step 308 it is then determined whether the arrival queue to which the packet has been allocated is full. If the queue is full, then in step 310 the packet is dropped.

If the queue is not full, then in step 312 the packet is transferred to the arrival queue.

Referring to FIG. 4, the process steps in further handling the packets are described. In a step 402 the arrival queues, such as the N queues 210, are scheduled by the device level scheduler, such as scheduler 214. As such, the packets in the arrival queues are scheduled to the device transfer queues, such as M queues 218, in a step 404.

The scheduling mechanism may be any standard mechanism such as strict priority, round robin, or weighted round robin scheduling. It is not important how the scheduling is done or what header indicates the priority. Packets are scheduled from the arrival queues based on the respective priority of each arrival queue.

The scheduling of packets from the arrival queues to the device transfer queues is in dependence on there being space available in the device transfer queues for the appropriate packets in the arrival queues.

In a step 406, packets are transferred from the device transfer queues to the processor transfer queues. The flow of packets from the device transfer queues to the processor transfer queues is dependent upon space being available in the processor transfer queues.

When a packet is transferred from a device transfer queue to a processor transfer queue, as denoted by step 408 an interrupt is generated to the processor. The handling of interrupts, and the further processing of packets, is described in further detail hereinbelow.

The flow of packets from the device transfer queues to the processor transfer queues may be by any conventional technique. Direct memory access (DMA) is a commonly used technique. The transfer queues may be DMA engines and their corresponding descriptor rings. If two DMA engines are provided, then two transfer queues are provided, one per engine. On the device side, packets are scheduled to the device transfer queues ready for transfer across the bus. When there is space on the processor side, i.e. in the corresponding queue in the processor memory, the DMA engine initiates a transfer and notifies the processor by interrupt after the transfer is complete.

The queuing functionality in the device may be implemented in hardware (e.g. ASIC or FPGA) or in software (or firmware) running on a processor such as a network processor or a communications processor.

In the embodiment described with reference to FIG. 2, there is shown an example in which a transfer queue generally comprises a device level transfer queue or queues and a processor level transfer queue. The invention is not limited to such a specific queuing arrangement.

In an alternative, the device level transfer queues may not be required, and packets may be transferred directly from the arrival queues to processor level transfer queues. An interrupt is generated in dependence on completion of a transfer of a packet to the processor level transfer queue.

In a further alternative, the device may not transfer packets directly to the processor level transfer queues. A further interrupt stage may be incorporated, with packets being transferred from either the arrival queues or the device level transfer queues to the processor level transfer queues in dependence upon generation of an interrupt signal.

In general, the embodiments of the invention provide for a transfer queue to which packets are transferred from the arrival queues. The implementation of the transfer queue may vary, and the technique for the transport of packets from the arrival queues to the transfer queues may vary.

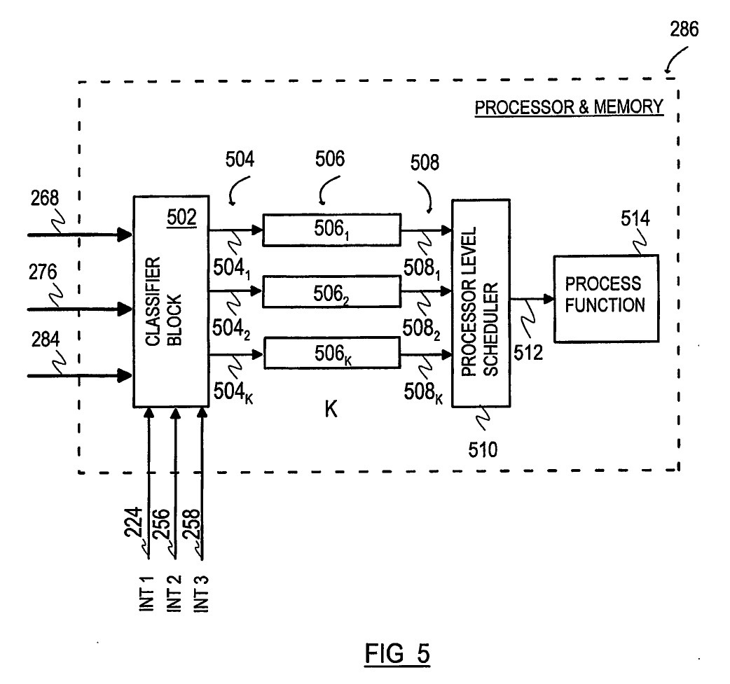

Turning now to FIG. 5, the implementation and operation of the processor and memory functionality block 286 of FIG. 2 is further illustrated. As shown in FIG. 5, the processor and memory functionality block 286 includes a classifier block 502, K queues 506₁ to 506_{K}, a processor level scheduler 510, and a process function 514.

The classifier block 502 receives the outputs of each of the processor transfer queues 268, 276, and 284. In addition the classifier block 502 receives each of the interrupt signals INT 1, INT 2, INT 3 on each of lines 224, 256, and 258 respectively. As is discussed further hereinbelow, the classifier block 502 allocates packets received from the packet transfer queues on lines 268, 276, and 284 to one of the K queues 506₁ to 506_{K}. The classifier block 502 thus is provided with a plurality K of outputs 504₁ to 504_{K}, each forming an input to one of the K queues. The K queues 506 are further provided with respective outputs 508₁ to 508_{K}, which forms inputs to the processor level scheduler 510. The output of the processor level scheduler on line 512 forms an input to the process function 514.

The processor and memory functionality block 286 places the packets into K queues after an interrupt service routine and before the actual packet processing.

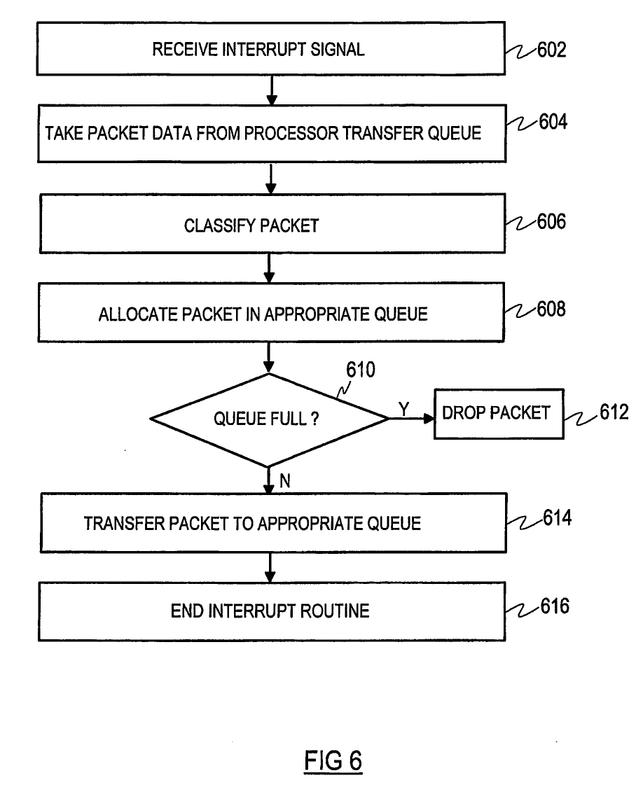

As discussed hereinabove with reference to FIG. 2, when a packet is transferred to one of the processor transfer queues an interrupt signal is generated by the device from which the packet originated. The packet then remains in the processor transfer queue pending execution of the interrupt. The further operation of the processor and memory functional block 286 is now further described with reference to the flow processor of FIG. 6.

As denoted by step 602, the classifier block 502 receives an interrupt signal from an external device. Responsive thereto, the processor and memory functional block 286 executes an interrupt service routine.

In step 604, the packet is taken from the appropriate transfer queue, 268, 276 or 284, associated with the interrupt signal, by the classifier block 502.

In a step 606, the classifier block 502 then classifies the packet. The classification of the packet may be based on a determination of the priority of the packet. The priority of the packet may be preferably determined by reading an appropriate field of the packet header.

Once the packet has been classified, then the appropriate one of the K queues to which the packet should be allocated is preferably known, as the packet is routed to the one of the K queues having the corresponding classification. This assumes that there is one queue available for each classification. There may be more or less than one queue available for each classification, in which case it is necessary to make a further determination of the allocation of the packet to a queue.

Once the queue to which the packet is to be allocated, based on classification, is determined, then the packet is placed in the appropriate one of the K queues, as denoted by step 608. Thus, the packet is transferred on one of the lines 504₁ to 504_{K} to the appropriate one of the queues 506₁ to 506_{K}.

After the packet is allocated to a particular one of the K queues, it is determined in step 610 whether the queue is full. If the queue is full, then in step 612 the packet is dropped. If the queue is not full, then in step 614 the packet is transferred to the appropriate queue.

Once the packet is placed in the queue, the interrupt routine is complete, as denoted by step 616.

Once the packets are allocated to one of the K queues, the processor level scheduler 510 applies a suitable algorithm to transfer packets from the queues to an appropriate packet processing stage, as represented by the process function 514. In practice, there may be a plurality of process functions, and the processor level scheduler 510 allocates the packet to the appropriate one of such plurality of process functions.

As with the device level scheduler, the processor level scheduler 510 may be any scheduling mechanism, and the implementation of the scheduler is outside the scope of the invention. The scheduler mechanism may, for example, be any standard mechanism such as strict priority, round robin, or weighted round robin scheduling. It is not important to the invention, or embodiments thereof, as to how the scheduling is done.

The processor and memory functional block 286 preferably handles overload situations by simply dropping packets from the queues that get full, (for example by ‘tail drop’ or one of the known RED algorithms). By adjusting different parameters of the system (such as, for example, the number of queues, the queue depths, the queue selection algorithm, and the packet scheduling algorithm from the queues) the system can conform to selected differentiated services quality of service properties for each traffic class.

The lowest priority queue of the K queues is typically most likely to drop packets and the highest priority queue is typically the least likely to drop packets. How this is achieved in practice depends on the selected scheduling mechanism, the queue length, the packet length etc. The lowest priority queue typically experiences the highest processing delays (latency) and delay variation.

In summary, in embodiments the packets are received from a network device or a switching fabric over a bus at a memory. The device notifies a processor of the available packets in the processor memory by using an interrupt. The interrupt causes the CPU to invoke an interrupt service routine which transfers the packets from a received buffer in memory to one of a plurality of input queues. The queue is selected for each packet based on a classification, such as a priority field, in the packet header.

Once allocated to a queue the packets wait for actual packet processing by the appropriate process function. If the process function is unable to handle packets at the rate they arrive, individual queues may become full and packets may be dropped from such queues. The latency of the packets in lower priority queues may increase in times of congestion.

An advantage of the invention is that the input direction (or ingress) queues may be made to comply with a selected quality of service (QoS) scheme, such as differentiated services, and packets may be treated according to the selected QoS scheme inside the system at all processing stages.

As such, the traffic class drop probabilities relative to each other can be controlled in the input path, and the traffic class latency relative to each other can be controlled in the input path.

In differentiated services, these two properties (drop probability and latency) determine the difference between two traffic classes. Therefore, they are very important properties that preferably should be controllable also inside the system. The invention provides this control.

A further advantage of the invention is in the improvement of usable bandwidth, since the techniques of embodiments of the invention do not try to limit the inbound traffic for some traffic classes (those that have the highest priority). The invention allows 100% processor utilization and may still provide adequate quality of service.

A still further advantage of the invention is that it simplifies overload control, since there are not any specific overload tasks or polling. The detection of overload is embedded in the embodiments of the invention and happens on a per-packet basis at each of the stages separately. It is not as expensive an operation in terms of CPU cycles as an additional overload control process, so the invention saves CPU time for the actual tasks.

The invention guarantees that high priority packets are not likely to be dropped even if the CPU cannot process packets at the rate that they come in. This is different from other solutions that restrict the incoming packet rate, or start dropping packets from queues even before the queues get full. The invention guarantees similar quality of service treatment end-to-end (delay and drop probabilities). The invention also guarantees that packets are treated according to their QoS profile at the packet processing stage(s), even if there is no hardware support, and assuming that the interrupt stage does not consume all system resources. With the hardware support for ingress queues, this feature gives a full end-to-end queuing system for a processor ingress path.

The invention may be implemented in any device where packet processing is based on a general purpose processor (CPU) and the enforcement of quality of service (QoS) is important. Such scenarios may, for example, be a serving GPRS support node and/or a gateway GPRS support node in 3G and GPRS core networks.

The invention may be especially advantageously implemented in devices that have network interface cards connected with a CPU using PCI or some other bus technology and network interface cards use DMA (direct memory access) or a similar method to transfer data.

The invention may be implemented in a system, where devices connect to a processor, as described herein by way of preferred embodiments. The invention may also, however, apply to an implementation in a single device, where the arrival and transfer queues are provided as part of a single device. Such a device may be, for example, a network interface card, or a combination of interface hardware and a network processor, where the network processor implements a queuing structure toward a CPU or multiple CPUs.

It should be noted that in the figures, for ease of explanation, there is shown dedicated lines for each priority/queue between various processing blocks. In a practical implementation, common bus/transfer resources may be used for all of the traffic classes, for example as a software function or as an electrical bus. The invention is thus not limited to the specifics of the exemplary implementation presented herein.

The invention has been described herein by way of reference to particular exemplary embodiments. It will be understood, however, that the invention is not limited to the detail of such examples. The scope of protection afforded by the invention is set out in the appended claims.

1. A method of queuing packets for processing, the method comprising the steps of:
a. allocating each received packet to at least one arrival queue;
b. placing each packet in the allocated queue if said queue is not full, otherwise dropping said packet;
c. scheduling packets from the arrival queue to at least one transfer queue;
d. responsive to transfer of a packet to a transfer queue, generating an interrupt;
e. responsive to receipt of an interrupt, allocating the packet to one of a plurality of processor queues;
f. placing the packet in the allocated processor queue if said queue is not full, otherwise dropping said packet; and
g. scheduling packets from the processor queues for processing.

2. A method according to claim 1 wherein packets are received at an input to a plurality of devices.

3. A method according to claim 1 wherein at least one device has a plurality of arrival queues

4. A method according to claim 3 wherein each arrival queue is associated with a traffic class, each packet being allocated to the at least one queue in accordance with the traffic class of each packet.

5. A method according to claim 4 wherein the traffic class is priority information embedded in the each packet.

6. A method according to claim 1 wherein at least one device comprises a plurality of transfer queues.

7. A method according to claim 1 wherein the number of transfer queues for each device is less than the number of arrival queues for each device.

8. A method according to claim 1 wherein the scheduling of packets from the arrival queue to the transfer queue is dependent upon one or more of: the traffic profile; the quality of service requirement; or the characteristics of the transfer queues.

9. A method according to claim 1 wherein the transfer queue comprises a device level transfer queue and a processor level transfer queue, wherein the device level transfer queue receives packets from the arrival queue, and the processor level transfer queue receives packets from the device level transfer queue.

10. A method according to claim 9 wherein packets are transferred to the processor level transfer queue from the device level transfer queue whenever there is space in the processor level transfer queue.

11. A method according to claim 10 wherein packets are never dropped from the transfer queue.

12. A method according to claim 1 wherein the processor queues are associated with different priorities.

13. A method according to claim 12 wherein the highest priority queue has the lowest drop probability and the lowest latency.

14. A method according to claim 1 wherein responsive to receipt of an interrupt from a device, a packet is removed from the transfer queue of the device and classified.

15. A method according to claim 14 wherein the classification is based on a determination of priority.

16. A method according to claim 14 wherein the packet is allocated to a processor queue in accordance with its classification.

17. A method according to claim 14 wherein the packet is placed in the allocated processor queue if said queue is not full, otherwise the packet is dropped.

18. A system including a processor and at least one device, in which system: packets for processing by the processor are received at an input of the at least one device, wherein the at least one device includes:
a. allocating means for allocating each received packet to at least one arrival queue of the device;
b. placement means for placing each packet in the allocated queue if said queue is not full, otherwise dropping said packet;
c. scheduling means for scheduling packets from the device arrival queue to at least one transfer queue; and
d. interrupt means, responsive to transfer of a packet to a transfer queue, for generating an interrupt from the device to a processor;
and wherein the processor includes:
e. allocation means, responsive to receipt of an interrupt, for allocating the packet to one of a plurality of processor queues;
f. placement means for placing the packet in the allocated processor queue if said queue is not full, otherwise dropping said packet; and
g. scheduling means for scheduling packets from the processor queues for processing.

19. A system according to claim 18 including a plurality of devices adapted to receive packets for processing by the processor at inputs thereof.

20. A system according to claim 18 in which at least one device is adapted to provide a plurality of arrival queues

21. A system according to claim 20 in which each arrival queue is associated with a traffic class, each packet being allocated to the at least one queue by the allocation means in accordance with the traffic class of each packet.

22. A system according to claim 21 in which the traffic class is priority information embedded in the each packet.

23. A system according to claim 18 in which at least one device includes a plurality of transfer queues.

24. A system according to claim 18 wherein the number of transfer queues for each device is less than the number of arrival queues for each device.

25. A system according to claim 18 in which the scheduling means is responsive to one or more of: the traffic profile; the quality of service requirement; or the characteristics of the transfer queues.

26. A system according to claim 18 in which the transfer queue comprises a device level transfer queue and a processor level transfer queue, the device level transfer queue being adapted to receive packets from the arrival queue, and the processor level transfer queue being adapted to receive packets from the device level transfer queue.

27. A system according to claim 26 being adapted such that packets are transferred to the processor level transfer queue from the device level transfer queue whenever there is space in the processor level transfer queue.

28. A system according to claim 27 further adapted such that packets are never dropped from the transfer queue.

29. A system according to claim 18 in which the processor queues are adapted to be associated with different priorities.

30. A system according to claim 29 in which the system is adapted such that the highest priority queue has the lowest drop probability and the lowest latency.

31. A system according to claim 18 wherein the processor includes transfer means adapted, responsive to receipt of an interrupt from a device, to remove a packet from the transfer queue of the device, and provide such to a classification means for classification.

32. A system according to claim 31 in which the classification is adapted to be based on a determination of priority.

33. A system according to claim 31 further including means to allocate the packet to a processor queue in accordance with its classification.

34. A system according to claim 31 where placement means are adapted such that the packet is placed in the allocated processor queue if said queue is not full, and otherwise the packet is dropped.

35. A device adapted for queuing packets to be processed, the device including:
a. allocating means for allocating a received packet to at least one arrival queue;
b. placement means for placing each packet in the allocated queue if said queue is not full, otherwise dropping said packet;
c. scheduling means for scheduling packets from the arrival queue to at least one transfer queue; and
d. interrupt means, responsive to transfer of a packet to a transfer queue, for generating an interrupt;
e. allocation means, responsive to receipt of an interrupt, for allocating the packet to one of a plurality of processor queues;
f. placement means for placing the packet in the allocated processor queue if said queue is not full, otherwise dropping said packet; and
g. scheduling means for scheduling packets from the processor queues for processing.

36. A device according to claim 35 including a plurality of arrival queues.

37. A device according to claim 36 in which each arrival queue is associated with a traffic class, each packet being allocated to the at least one queue by the allocation means in accordance with the traffic class of each packet.

38. A device according to claim 35 including a plurality of transfer queues.

39. A device according to claim 35 in which the transfer queue comprises a device level transfer queue and a processor level transfer queue, the device level transfer queue being adapted to receive packets from the arrival queue, and the processor level transfer queue being adapted to receive packets from the device level transfer queue.

40. A device according to claim 39 being adapted such that packets are transferred to the processor level transfer queue from the device level transfer queue whenever there is space in the processor level transfer queue.

41. A device according to claim 40 further adapted such that packets are never dropped from the transfer queue.

42. A device according to claim 35 in which the processor queues are adapted to be associated with different priorities.

43. A device according to claim 35 further including transfer means adapted, responsive to receipt of an interrupt, to remove a packet from the transfer queue of, and provide such to a classification means for classification.

44. A device according to claim 35 further including means to allocate the packet to a processor queue in accordance with its classification.

45. A device according to claim 44 in which the placement means are adapted such that the packet is placed in the allocated processor queue if said queue is not full, and otherwise the packet is dropped.
